(19) United States
(12) Patent Application Publication
(10) Pub. No.: US 2023/0304451 A1
(43) Pub. Date: Sep. 28, 2023

(54) ENGINE CONTROLLER

(71) Applicant: TOYOTA JIDOSHA KABUSHIKI KAISHA, Toyota-shi, Aichi-ken (JP)

(72) Inventor: Manabu ISHIMOTO, Miyoshi-shi (JP)

(73) Assignee: TOYOTA JIDOSHA KABUSHIKI KAISHA, Toyota-shi, Aichi-ken (JP)

(21) Appl. No.: 18/181,628

(22) Filed: Mar. 10, 2023

(30) Foreign Application Priority Data
Mar. 25, 2022 (JP) 2022-049634

(51) Int. Cl. F02D 41/00

(52) U.S. Cl. CPC F02D 41/0002; F02D 2200/0404; F02D 2200/0414; F02D 2200/703; F02D 2200/501

(57) ABSTRACT

An engine controller includes processing circuitry. The processing circuitry is configured to, when an engine rotation speed is within a specified range, perform a throttle limit control that reduces an upper limit throttle opening degree, the upper limit throttle opening degree being an upper limit value of a control range of an opening degree of a throttle valve of an engine.

### BACKGROUND

### 1. Field

The present disclosure relates to an engine controller that controls a throttle valve.

### 2. Description of Related Art

Japanese Laid-Open Patent Publication No. 2009-174384 discloses an intake manifold that is capable of varying the lengths of branch pipes.

In an engine, pulsation occurs in the flow of intake air in the intake passage due to intermittent inflow of the intake air into combustion chambers in response to opening and closing of intake valves. The frequency of such intake air pulsation changes depends on the engine rotation speed. Therefore, in a specific engine rotation speed range, the frequency of intake air pulsation and the resonance frequency of the intake system agree with each other, so that low-frequency vibration and noise, which are referred to as booming noise, are generated.

When the lengths of the branch pipes of the intake manifold changes, the resonance frequency of the intake system changes. Therefore, in an engine provided with the intake manifold described in the above publication, the resonance frequency of the intake system is changed in accordance with the engine rotation speed so as not to overlap with the frequency of the intake air pulsation. This suppresses the generation of booming noise. However, the complicated mechanism for varying the lengths of the branch pipes of the intake manifold increases the manufacturing costs of the engine.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an engine controller includes processing circuitry. The processing circuitry is configured to, when an engine rotation speed is within a specified range, perform a throttle limit control that reduces an upper limit throttle opening degree. The upper limit throttle opening degree is an upper limit value of a control range of an opening degree of a throttle valve of an engine.

Other features and aspects will be apparent from the following detailed description, the drawings, and the claims.

### BRIEF DESCRIPTION OF THE DRAWINGS

FIG. 1 is a schematic diagram showing an engine controller according to one embodiment.

FIG. 2 is a flowchart of a throttle control routine executed by the engine controller shown in FIG. 1.

FIG. 3 is a graph showing a relationship between an engine rotation speed and an upper limit throttle opening degree in a calculation map used in the throttle control routine shown in FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

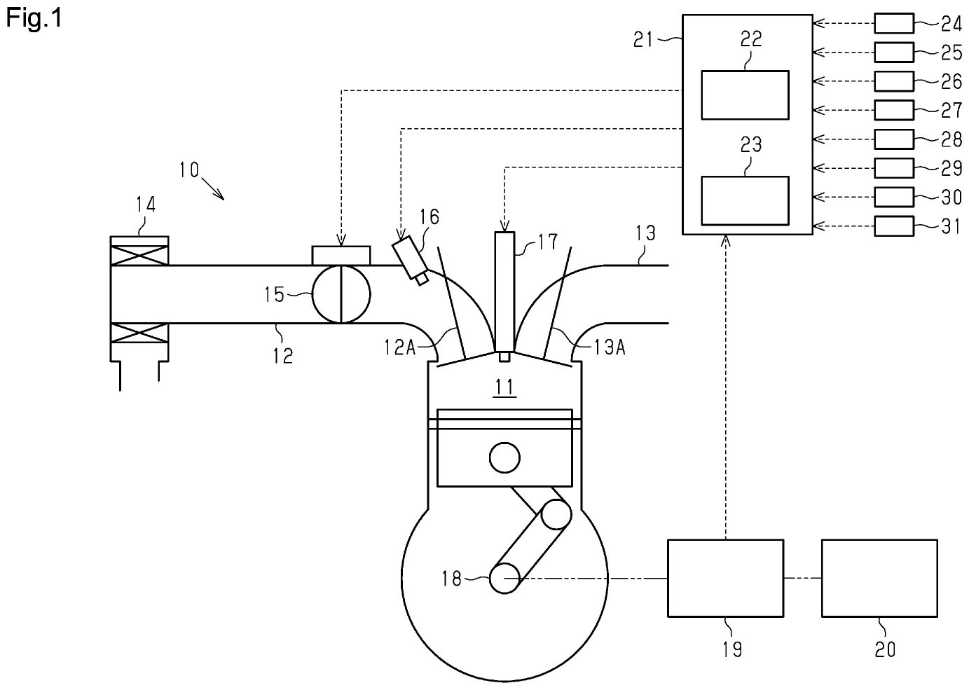

An engine controller according to one embodiment will be described with reference to FIGS. 1 to 3.

<Configuration of Engine Controller>

First, the configuration of the engine controller according to the present embodiment will be described with reference to FIG. 1. An engine 10 shown in FIG. 1 is a vehicle on-board spark-ignition type internal combustion engine.

The engine 10 includes a combustion chamber 11, in which an air-fuel mixture of intake air and fuel is combusted, an intake passage 12, which is a passage for introducing intake air into the combustion chamber 11, and an exhaust passage 13, which is a passage for discharging exhaust gas generated by the combustion of the air-fuel mixture in the combustion chamber 11. The combustion chamber 11 is connected to the intake passage 12 via an intake valve 12A and to the exhaust passage 13 via an exhaust valve 13A.

The intake passage 12 is provided with an air cleaner 14, which filters out dust and the like from the intake air, a throttle valve 15, which changes an inflow amount of the intake air into the combustion chamber 11 by changing the opening area, and an injector 16, which injects fuel into the intake air. The combustion chamber 11 is provided with an ignition device 17, which ignites air-fuel mixture by spark discharge. A crankshaft 18, which is an output shaft of the engine 10, is connected to wheels 20 via an automatic transmission 19.

The engine controller according to the present embodiment includes an engine control module (ECM) 21. The throttle valve 15, the injector 16, and the ignition device 17 of the engine 10 are controlled by the ECM 21. The ECM 21 includes a memory device 22, which stores programs and data for engine control, and a processor 23, which reads programs from the memory device 22 and executes the programs. The ECM 21 is connected to various types of sensors installed in multiple locations in the vehicle. The ECM 21 controls the engine 10 by controlling the opening degree of the throttle valve 15, the fuel injection amount of the injector 16, the ignition timing of the ignition device 17, and the like based on the detection results of the sensors.

The sensors connected to the ECM 21 include an air flow meter 24, a crank angle sensor 25, a coolant temperature sensor 26, an intake air temperature sensor 27, an outside air temperature sensor 28, an outside atmospheric pressure sensor 29, an accelerator pedal sensor 30, and a vehicle speed sensor 31. The air flow meter 24 is a sensor that detects an intake air flow rate GA in the intake passage 12. The crank angle sensor 25 is a sensor that detects a rotational phase of the crankshaft 18. The coolant temperature sensor 26 is a sensor that detects an engine coolant temperature THW, which is the temperature of the engine coolant. The intake air temperature sensor 27 is a sensor that detects an intake air temperature THA, which is the temperature of the intake air in the intake passage 12. The outside air temperature sensor 28 is a sensor that detects an outside air temperature THAO, which is the temperature of the air outside the vehicle. The outside atmospheric pressure sensor 29 is a sensor that detects an outside atmospheric pressure PA, which is the pressure of the air outside the vehicle. The accelerator pedal sensor 30 is a sensor that detects an operated amount ACC of the accelerator pedal by the driver. The vehicle speed sensor 31 is a sensor that detects a vehicle speed V of the vehicle on which the engine 10 is mounted. The ECM 21 obtains an engine rotation speed NE based on a detection result of the crank angle sensor 25. The ECM 21 receives information on the currently selected gear position of the automatic transmission 19. The gear position of the automatic transmission 19 indicates the gear ratio of the automatic transmission 19.

<Opening Degree Control of Throttle Valve 15>

Next, an opening degree control of the throttle valve 15 performed by the ECM 21 will be described. The opening degree of the throttle valve 15 will hereafter be referred to as a throttle opening degree TA.

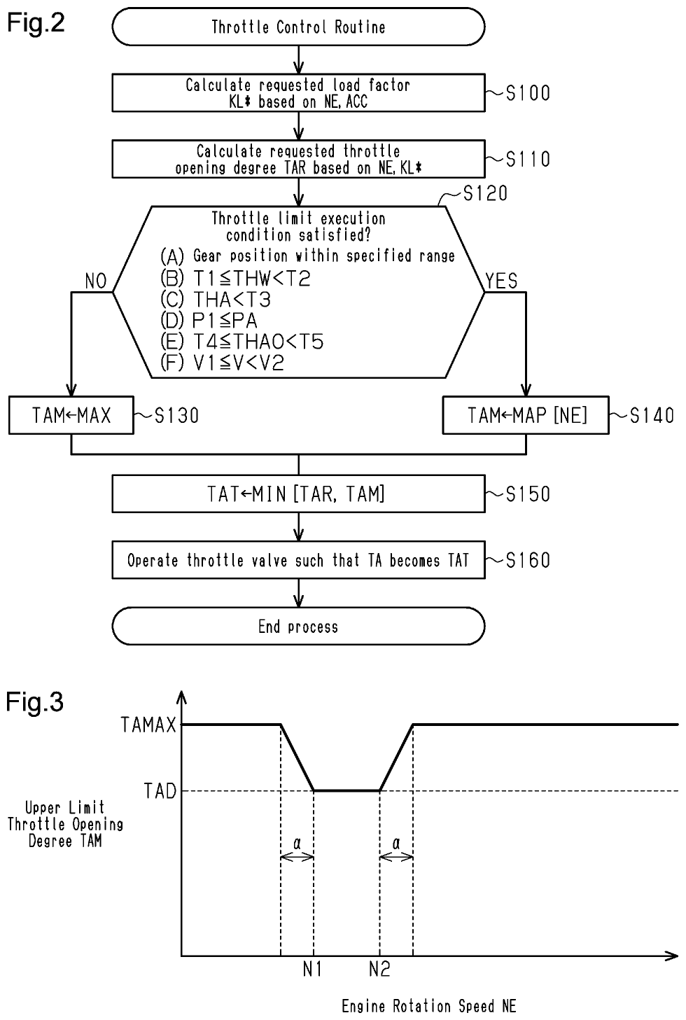

FIG. 2 is a flowchart of a throttle control routine executed by the ECM 21 to control the throttle opening degree TA. The ECM 21 repeatedly executes the routine at each specified control cycle during the operation of the engine 10.

When the process of this routine is started, the ECM 21 first calculates, in step S100, a requested load factor KL*, which is a requested value of the load factor KL of the engine 10, based on the engine rotation speed NE and the operated amount ACC of the accelerator pedal. The load factor KL of the engine 10 represents a filling factor of intake air in the combustion chamber 11.

Next, in step S110, the ECM 21 calculates a requested throttle opening degree TAR based on the engine rotation speed NE and the requested load factor KL*. The ECM 21 calculates, as the value of the requested throttle opening degree TAR, the throttle opening degree TA at which the load factor KL equal to the value of the requested load factor KL* is obtained at the current engine rotation speed NE.

Subsequently, in step S120, the ECM 21 determines whether a throttle limit execution condition is satisfied. The throttle limit execution condition is satisfied when all the following requirements (A) to (F) are satisfied.

(A) The gear position of the automatic transmission 19 is within a specified range. The specified range is a middle speed range excluding gear positions in a low speed range used for starting or accelerating the vehicle, and gear positions in a high speed range used for high-speed cruising of the vehicle.

(B) The engine coolant temperature THW is greater than or equal to the execution lower limit coolant temperature T1 and less than an execution upper limit coolant temperature T2. The execution lower limit coolant temperature T1 is set to a lower limit value of a proper range of the engine coolant temperature THW, and the execution upper limit coolant temperature T2 is set to an upper limit value of the proper range. The proper range is a range of the engine coolant temperature THW in which the engine 10 properly exhibits performance, that is, a range of the engine coolant temperature THW in which warm-up of the engine 10 is completed and the engine 10 does not become overheated.

(C) The intake air temperature THA is lower than an execution upper limit intake air temperature T3. When the intake air temperature THA is relatively high, the charging efficiency of the intake air in the combustion chamber 11 decreases due to thermal expansion of the intake air, and the output performance of the engine 10 decreases. The execution upper limit intake air temperature T3 is set to an upper limit value of the intake air temperature THA at which a decrease in the output performance of the engine 10 remains within an allowable range even when the throttle limit control, which will be discussed below, is executed.

(D) The outside atmospheric pressure PA is more than or equal to an execution lower limit air pressure P1. When the outside atmospheric pressure PA decreases, the charging efficiency of the intake air in the combustion chamber 11 decreases, and the output performance of the engine 10 is reduced. The execution lower limit intake air pressure P1 is set to a lower limit value of the outside atmospheric pressure PA at which a decrease in the output performance of the engine 10 remains within an allowable range even when the throttle limit control, which will be discussed below, is executed.

(E) The outside air temperature THAO is greater than or equal to an execution lower limit outside air temperature T4 and is less than an execution upper limit outside air temperature T5. The engine 10 is designed on the assumption that it is used at an outside air temperature THAO within a specified normal use ambient temperature range. The execution lower limit outside air temperature T4 is set to a lower limit value of the normal use ambient temperature range, and the execution upper limit outside air temperature T5 is set to an upper limit value of the normal use ambient temperature range.

(F) The vehicle speed V is greater than or equal to an execution lower limit vehicle speed V1 and is less than an execution upper limit vehicle speed V2. The execution lower limit vehicle speed V1 is set to a lower limit value of a vehicle speed range in which the booming noise of intake air becomes a problem, and the execution upper limit vehicle speed V2 is set to an upper limit value of that vehicle speed range. When the vehicle is traveling at a relatively high speed, background noise including wind roar and road noise increases. The booming noise of intake air increases when the throttle valve 15 is opened more than a certain degree. When the vehicle speed V is low, the throttle opening degree TA becomes large when the vehicle is accelerating. When the vehicle is accelerating, the background noise increases. Even if the booming noise of intake air is generated when the background noise is relatively loud, the booming noise is mixed with the background noise, so that the booming noise of intake air is unlikely to become a problem. Accordingly, the booming noise of intake air becomes a problem in vehicle speed ranges other than low vehicle speed ranges and high vehicle speed ranges.

When determining, in the above-described step S120, that the throttle limit execution condition is not satisfied (NO), the ECM 21 advances the process to step 5130. When determining that the condition is satisfied (YES), the ECM 21 advance the process to step S140. In step S130, the ECM 21 sets an upper limit throttle opening degree TAM to a specified maximum opening degree TAMAX. In step S140, the ECM 21 calculates the value of the upper limit throttle opening degree TAM based on the engine rotation speed NE using a calculation map MAP stored in the memory device 22. After the process of step S130 or step S140, the ECM 21 advances the process to step S150.

FIG. 3 shows a relationship between the engine rotation speed NE and the upper limit throttle opening degree TAM in the calculation map MAP used in the calculation in step S140. Symbols N1 and N2 in FIG. 3 respectively represent the lower limit value and the upper limit value of a range of the engine rotation speed NE in which the frequency of the intake air pulsation and the resonance frequency of the intake system overlap with each other. On the calculation map MAP of FIG. 3, the value of the upper limit throttle opening degree TAM is set to the maximum opening degree TAMAX in a region in which the engine rotation speed NE is less than the value represented by N1−α and in a region in which the engine rotation speed NE exceeds the value represented by N2+α. In a region in which the engine rotation speed NE is greater than or equal to N1 and less than or equal to N2, the value of the upper limit throttle opening degree TAM is set to a specified throttle opening degree TAD, which is less than the maximum opening degree TAMAX. The value of the upper limit throttle opening degree TAM is set such that it gradually changes between the maximum opening degree TAMAX and the throttle opening degree TAD in the region of the engine rotation speed NE of N1−α to N1 and in the region of the engine rotation speed NE of N2 to N2+α.

When the process proceeds to step S150, the ECM 21 sets the value of a target throttle opening degree TAT to the smaller value of the requested throttle opening degree TAR and the upper limit throttle opening degree TAM. In the subsequent step S160, the ECM 21 controls the throttle valve 15 such that the throttle opening degree TA approaches the target throttle opening degree TAT. Then, the ECM 21 ends the process of this routine in the current control cycle. In the present embodiment, the processes of step S120, step S140, and step S150 in the throttle control routine correspond to the throttle limit control.

<Operation and Advantages of Embodiment>

Operation and advantages of the present embodiment will now be described.

The booming noise of intake air of the engine 10 is generated in a range of the engine rotation speed NE in which the frequency of the intake air pulsation and the resonance frequency of the intake system overlap with each other. The intake air pulsation is generated by opening and closing of the intake valve 12A. The intake air pulsation is propagated to the upstream side of the intake passage 12 through the intake passage 12. When the throttle opening degree TA is reduced, the intake air pulsation is less likely to be transmitted to a portion of the intake passage 12 on the upstream side of the throttle valve 15, so that the booming noise of intake air is reduced.

When the engine rotation speed NE is within a range in which booming noise of intake air is likely to be generated, the ECM 21 performs the throttle limit control for reducing the upper limit throttle opening degree TAM, which is the upper limit value of the control range of the throttle opening degree TA. At this time, the throttle valve 15 is not opened beyond the reduced upper limit throttle opening degree TAM. This suppresses the booming noise of intake air.

When the upper limit throttle opening degree TAM is reduced, the maximum output of the engine 10 decreases. The maximum output, as used in this description, does not refer to a value in the catalog specification, but refers to the maximum value of the output that can be generated by the engine 10 at a given moment. Based on the engine coolant temperature THW, the intake air temperature THA, the outside atmospheric pressure PA, the outside air temperature THAO, the vehicle speed V, and the gear position of the automatic transmission 19, the ECM 21 reduces the upper limit throttle opening degree TAM only under the following condition. The ECM 21 reduces the upper limit throttle opening degree TAM only in a situation in which a high engine output is not required and the booming noise of intake air is likely to become a problem.

The engine controller of the present embodiment has the following advantages.

(1) When the engine rotation speed NE is within a range in which the booming noise of intake air is likely to be generated, the throttle limit control is performed to reduce the upper limit throttle opening degree TAM, which is the upper limit value of the control range of the throttle opening degree TA of the engine 10. This suppresses the booming noise of intake air.

(2) The upper limit throttle opening degree TAM is reduced only in a limited rotation speed range. Therefore, the reduction in the output performance of the engine 10 due to suppression of booming noise of intake air occurs in a limited portion of the operation range of the engine 10. That is, the original output performance of the engine 10 can be obtained in rotation speed ranges outside the above-described range.

(3) Booming noise of intake air is suppressed only by changing software without adding hardware. Therefore, the increase in the manufacturing costs of the engine 10 is limited to that caused by the change in the control program.

(4) The upper limit throttle opening degree TAM is reduced in the throttle limit control only in a situation in which a high engine output is not required and the booming noise of intake air is likely to become a problem. Therefore, suppression of the booming noise of intake air and the output performance of the engine 10 are both ensured in a favorable manner.

(5) The upper limit throttle opening degree TAM is reduced through the throttle limit control on condition that the engine coolant temperature THW is within the specified range. Therefore, it is possible to suppress the booming noise of intake air within a range in which the engine coolant temperature THW can be maintained in a proper range.

(6) The upper limit throttle opening degree TAM is reduced through the throttle limit control on condition that the intake air temperature THA of the engine 10 is less than the specified temperature. This prevents a decrease in the charging efficiency of intake air due to thermal expansion and a decrease in the upper limit throttle opening degree TAM from coinciding with each other. The output performance of the engine 10 is thus not reduced significantly.

(7) The upper limit throttle opening degree TAM is reduced through the throttle limit control on condition that the outside atmospheric pressure PA is greater than or equal to the specified pressure. This prevents a decrease in the charging efficiency of intake air due to a decrease in the intake air density in a low atmospheric pressure environment and a decrease in the upper limit throttle opening degree TAM from coinciding with each other. The output performance of the engine 10 is thus not reduced significantly.

(8) The upper limit throttle opening degree TAM is reduced through the throttle limit control on condition that the outside air temperature THAO is within the specified range. This prevents the operating state of the engine 10 from deteriorating as a result of reduction in the upper limit throttle opening degree TAM in an environment of extremely low temperatures or extremely high temperatures.

(9) The upper limit throttle opening degree TAM is reduced through the throttle limit control on condition that the vehicle speed V, which is the traveling speed of the vehicle on which the engine 10 is mounted, is within the specified range. Therefore, the output performance of the engine 10 is not reduced through the throttle limit control in vehicle speed ranges in which the background noise is so loud that the booming noise of intake air is unlikely to become a problem.

(10) The upper limit throttle opening degree TAM is reduced through the throttle limit control on condition that the gear position of the automatic transmission 19 is in the specified range, that is, the gear ratio of the automatic transmission 19 is within the specified range. Therefore, the output performance of the engine 10 is not reduced through the throttle limit control when the vehicle is started, accelerated, or traveling at a relatively high speed, which requires a high output performance.

The above-described embodiment may be modified as follows. The above-described embodiment and the following modifications can be combined if the combined modifications remain technically consistent with each other.

One or more of the requirements (A) to (F) for the throttle limit execution condition may be omitted. Other requirements may be added to the throttle limit execution condition.

Instead of setting the throttle limit execution condition, the upper limit throttle opening degree TAM may be reduced only on condition that the engine rotation speed NE is within a specified range in the throttle limit control.

The throttle limit control of the above-described embodiment can be used in an engine other than the engine shown in FIG. 1.

The ECM 21 is not limited to a device that includes the memory device 22 and the processor 23. For example, the ECM 21 may include a dedicated hardware circuit (e.g. an application specific integrated circuit: ASIC) that executes at least part of the processes executed in the above-described embodiment. That is, the ECM21 may be processing circuitry that includes any one of the following configurations (a) to (c).

(a) Processing circuitry including a processor that executes all of the above-described processes according to programs and a program storage device such as a ROM that stores the programs.

(b) Processing circuitry including a processor and a program storage device that execute part of the above-described processes according to the programs and a dedicated hardware circuit that executes the remaining processes.

(c) Processing circuitry including a dedicated hardware circuit that executes all of the above-described processes.

Multiple software processing devices each including a processor and a program storage device and multiple dedicated hardware circuits may be provided.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine controller, comprising processing circuitry, wherein the processing circuitry is configured to, when an engine rotation speed is within a specified range, perform a throttle limit control that reduces an upper limit throttle opening degree, the upper limit throttle opening degree being an upper limit value of a control range of an opening degree of a throttle valve of an engine.

2. The engine controller according to claim 1, wherein the processing circuitry is configured to reduce the upper limit throttle opening degree through the throttle limit control on condition that an engine coolant temperature is within a specified range.

3. The engine controller according to claim 1, wherein the processing circuitry is configured to reduce the upper limit throttle opening degree through the throttle limit control on condition that an intake air temperature of the engine is less than a specified temperature.

4. The engine controller according to claim 1, wherein the processing circuitry is configured to reduce the upper limit throttle opening degree through the throttle limit control on condition that an outside atmospheric pressure is greater than or equal to a specified pressure.

5. The engine controller according to claim 1, wherein the processing circuitry is configured to reduce the upper limit throttle opening degree through the throttle limit control on condition that an outside air temperature is within a specified range.

6. The engine controller according to claim 1, wherein the processing circuitry is configured to reduce the upper limit throttle opening degree through the throttle limit control on condition that a traveling speed of a vehicle on which the engine is mounted is within a specified range.

7. The engine controller according to claim 1, wherein the processing circuitry is configured to reduce the upper limit throttle opening degree through the throttle limit control on condition that a gear ratio of a transmission of a vehicle on which the engine is mounted is within a specified range.

8. The engine controller according to claim 1, wherein the specific range of the engine rotation speed is a range of the engine rotation speed in which a frequency of an intake air pulsation that occurs in an intake system of the engine and a resonance frequency of the intake system overlap with each other.
